(19) United States
(12) Patent Application Publication
(10) Pub. No.: US 2008/0009270 A1
(43) Pub. Date: Jan. 10, 2008

(54) Method of marketing educational or entertainment content stored on an optical disc using a portable wireless handset functioning as a mobile storefront

(75) Inventors: Steven B. Volk, Boulder, CO (US); PK Bala, Lafayette, CO (US); Wendy T. Volan, Longmont, CO (US)

Correspondence Address: PATENTABILITY ASSOCIATES, P.O. BOX 9551, SAN JOSE, CA, 95157, US

(73) Assignee: Vmedia Research, Inc., Boulder, CO (US)

(21) Appl. No.: 11/481,226

(22) Filed: Jul. 5, 2006

(51) Int. Cl. H04Q 7/38

(52) U.S. Cl. 455/414.1

(57) ABSTRACT

A portable wireless handset such as a mobile phone is used as a “mobile storefront” which allows the user to preview and order entertainment and/or educational content, such as movies or games. By communicating with a wireless mobile storefront service platform, the user can view excerpts or trailers of the content to her handset to determine if she wishes to purchase or rent the content. Upon ordering the content, an optical disc containing the content is shipped to the user, and the charge for the content is transmitted to a billing service, such as a mobile carrier for inclusion in the user's monthly bill. The optical disc shipped to the user may be used to view the content on the handset. The disc may also contain locked content. If the user wishes to view the locked content she transmits a request to the storefront service platform, which transmits a key to the handset, allowing the user to view the locked content.

### FIELD OF THE INVENTION

This invention relates to a method of providing for the convenient selection and ordering of a movie or other educational or entertainment content without the necessity of visiting a retail store or accessing an online website via a personal computer.

### BACKGROUND OF THE INVENTION

At present, there are two main methods by which a movie or other entertainment or educational content may be selected and purchased or rented.

The first method is to visit a retail location, either a store that is devoted exclusively to the sale and/or rental of such content (e.g., DVDs or tapes) or a grocery, convenience or other type of store that has a department for that purpose. This can involve considerable time and expense. The customer must frequently make a special trip to the retail outlet. Even if the customer needs to visit the store for another reason, in the case of a rental she may need to make a special trip to return the DVD or tape to the store after viewing it. Moreover, it is not normally possible to preview the movie in this situation. In many cases, the customer may have only a vague idea of what the selected movie is about and may regret the decision to purchase or rent it when she gets it home.

Ordering online via a personal computer is somewhat more convenient, but still the customer must boot up her computer and go to the appropriate website. In addition, to order a movie the customer often must provide the online supplier with her credit card information to complete the transaction. And it is frequently not convenient to preview the selection before it is purchased or rented.

Clearly, it would be desirable to provide a more convenient way of selecting, previewing and ordering a movie or other entertainment or educational content.

### SUMMARY OF THE INVENTION

A virtual mobile store for the selection, preview, purchase and/or rental of packaged media, such as optical discs, containing pre-recorded video content is accessed by a handheld, wireless device such as a mobile phone handset. The wireless mobile storefront is accessed and data is transmitted over any wireless network, including cellular telephone networks and wireless high fidelity networks (WiFi, WiMax). The wireless device incorporates a miniature optical drive used for playback of rich content such as motion pictures, television series, games, sports events and educational content pre-recorded on the optical disc.

A wireless mobile storefront service platform serves content catalogs, content descriptions, content previews (trailers) and online community features to the handheld, wireless device. The wireless mobile storefront service platform allows the user to browse content catalogs, preview content, purchase or rent content on packaged optical media, and manage content purchases and rentals via the handheld wireless device. The wireless mobile storefront service platform is operated by a service platform operator—typically a content wholesaler who distributes content to content retailers. The wireless mobile storefront service platform is capable of identifying specific wireless handset users and transparently routing those users to an appropriate content retailer-branded interface. Multiple content retailer-branded interfaces can be served simultaneously through the wireless mobile storefront service platform.

A content retailer may utilize the wireless mobile storefront service platform to send previews of entertainment or educational content via wireless networks to the handset for viewing by the user. The user can perform a rental or purchase transaction from the virtual mobile storefront via the handset in addition to managing a rental or purchase queue on the handset which specifies the order in which content will be delivered to the user. The content retailer may bill the user for content purchased or rented.

Purchased or rented content is typically delivered to the user on an optical disc via the postal service or other physical delivery service. In the case of a rental transaction, the optical disc is shipped in a reusable package with return shipping or postage prepaid. The optical disc is preferably a miniature optical disc that may be used to display the content on the handset. The optical disc may incorporate a copy protection system of the kind described in application Ser. No. 10/383,193, incorporated herein by reference in its entirety, which prevents the content on the disc from being copied. Alternatively, the optical disc could incorporate an industry standard copy protection system or no copy protection system.

The optical disc may also contain additional content which is locked but can be previewed by the user on a wireless handset and subsequently purchased and unlocked via the wireless storefront service platform through an electronic transaction which sends a key code to the wireless handset. The content retailer may bill the user for purchases of locked content.

In one embodiment of the invention, the content retailer is a mobile carrier (also known as a wireless carrier or mobile network operator) and the wireless handset is a mobile phone. The mobile phone contains a miniature optical disc drive as described in application Ser. No. 10/423,701, now U.S. Pat. No. 7,058,959, issued Jun. 6, 2006, and application Ser. No. 11/234,356, each of which is incorporated herein by reference in its entirety. The mobile carrier's customers who choose to subscribe to the service (store members) may use their mobile phones to preview and order movies. For example, the mobile carrier may transmit a list of movies that are available for purchase or rent to store members. By selecting a movie from the list, the member is able to view an excerpt of the movie (commonly referred to as a “trailer”) to decide if she wishes to purchase or rent the entire movie. The content of the trailer is transmitted by the operator of the wireless mobile storefront service platform to the member over the mobile carrier's network.

If the member wishes to purchase or rent the movie, she transmits the decision over the network to the wireless mobile storefront service platform. In response to the order, the operator of the wireless mobile storefront service platform arranges for the shipment of an optical disc that contains the movie to the member. The disc is preferably a miniature optical disc that can be played on the member's mobile phone. The shipment may occur using the postal service or a delivery service. In the case of a rental transaction, the optical disc may be shipped in a reusable package with the return postage or shipment charges prepaid.

In a preferred embodiment, the mobile carrier bills the charge for the movie to the member's account, and it appears on the next (typically monthly) invoice. There is no need for the carrier to obtain credit card or other charge information from the member or to approve the member's creditworthiness, since the member has already established an account with the carrier. The member is conveniently able to pay for the movie with the same check or online payment that she uses to pay the carrier's monthly service fee.

Preferably, the miniature optical disc incorporates a system that prevents the content of the disc from being copied and thereby protects the intellectual property rights of the owner of the content. The optical disc may also contain additional “bonus” content which is locked but can be previewed by the member on the mobile phone and subsequently purchased and unlocked via the mobile carrier's network. If the member elects to purchase the “bonus” content, the carrier may unlock it by transmitting a key to the wireless handset. The charge for the locked “bonus” content may also be included in the member's periodic invoice from the carrier.

As mobile phones are becoming more and more widespread, an increasing percentage of the mobile phones in use are “smart phones.” Many users leave their mobile phones on throughout the day, so it is a simple matter to take a few minutes to preview and order a movie. People who are employed may easily do this on their lunch hour or during a break, for example, times when it may not be possible to visit a retail location or access the internet from a personal computer.

Using the principles of this invention the member's mobile phone is in effect converted into a “mobile storefront” that can be used for the purchase or rental of a wide variety of educational or entertainment content, including movies, television series, games, sport events and other educational content. The “mobile storefront” is attractive from a commercial standpoint because it decreases the traditional reliance on retail shelf space and foot traffic into retail locations.

### BRIEF DESCRIPTION OF THE DRAWINGS

FIG. 1 contains a flow chart that illustrates one embodiment of the invention.

FIGS. 2A-2K are views of the screen of a mobile phone or other wireless handset that may be used in the method of this invention.

FIG. 3A illustrates a system architecture for a mobile storefront in accordance with the invention.

FIGS. 3B and 3C illustrate alternative system architectures.

FIG. 4 illustrates how a transaction might be handled in the system of FIG. 3A.

FIG. 5 illustrates a transaction in which a key is used to unlock content on a disc that is purchased or rented by a customer.

FIG. 6 contains a flow chart illustrating the method described in FIG. 5.

FIG. 7 illustrates a possible structure among the operator of the wireless mobile storefront service platform and third parties.

### DESCRIPTION OF THE INVENTION

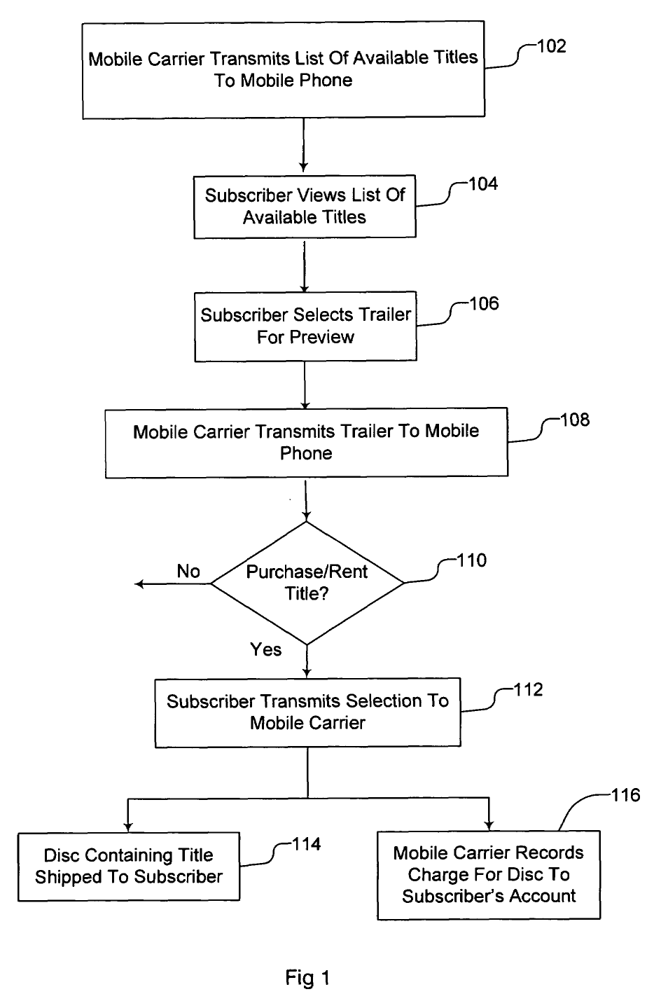

FIG. 1 contains a flow chart that illustrates one embodiment of a method according to the invention. It should be understood that the embodiment illustrated in FIG. 1 is subject to numerous modifications and variations, some but not all of which will be described herein.

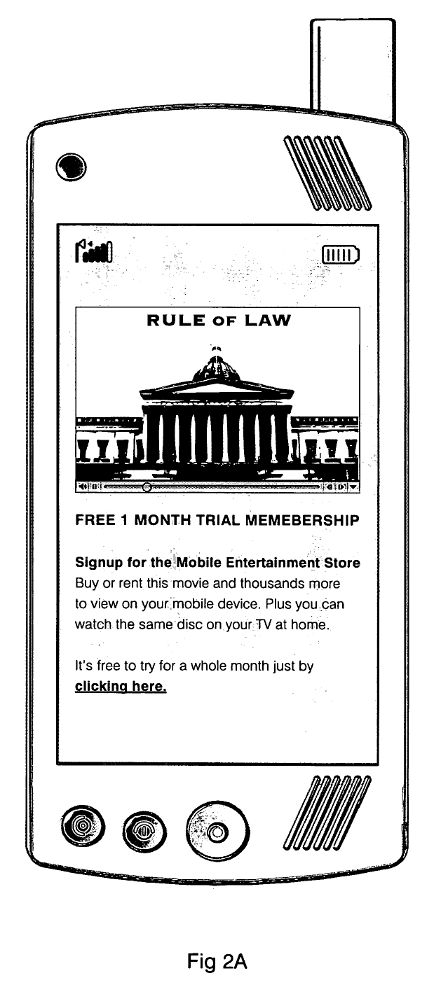

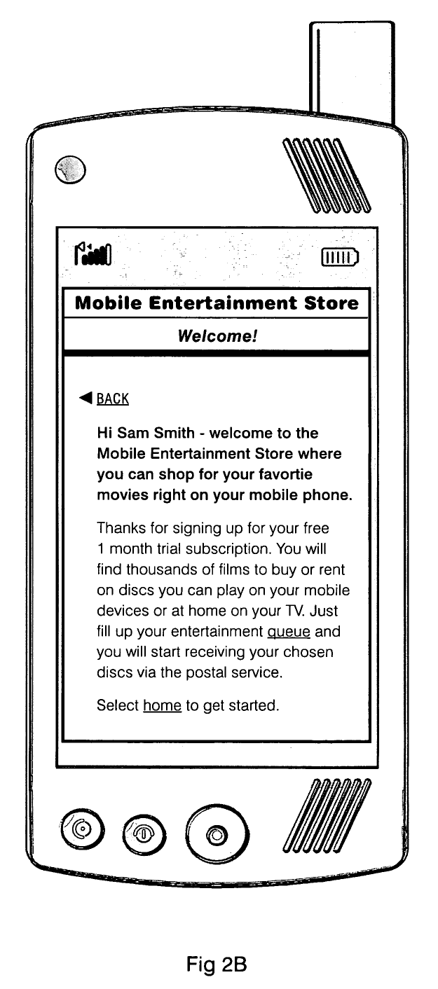

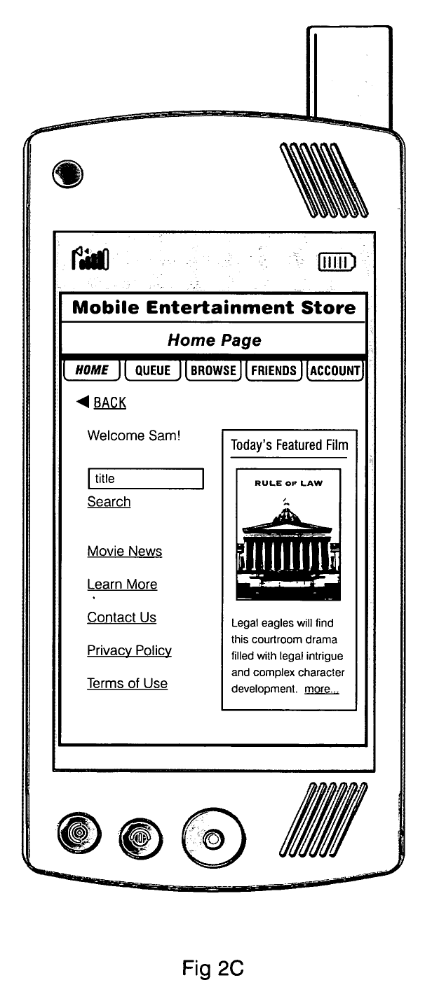

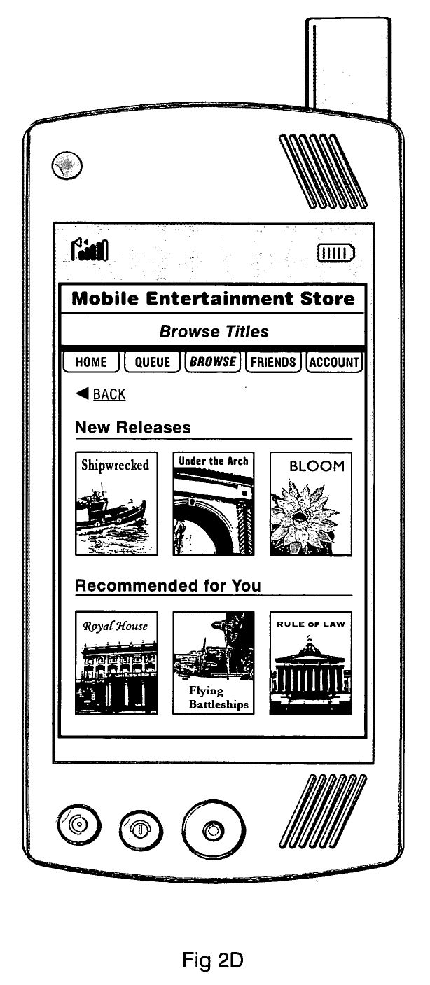

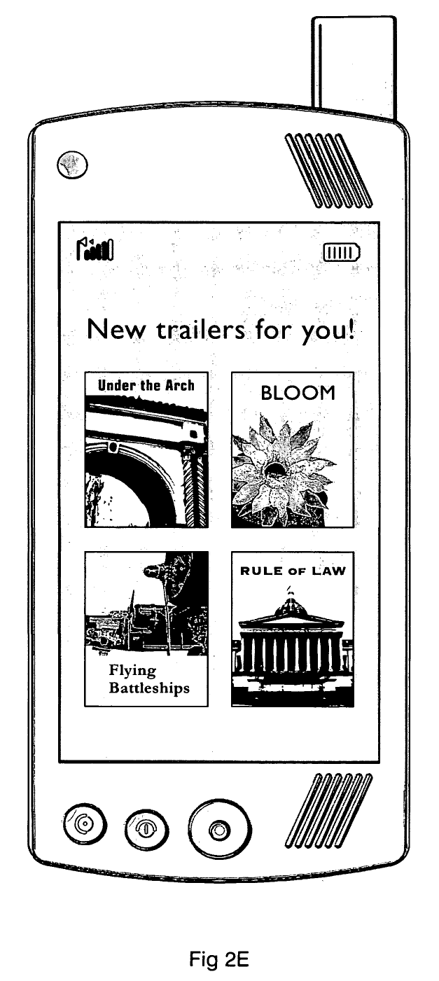

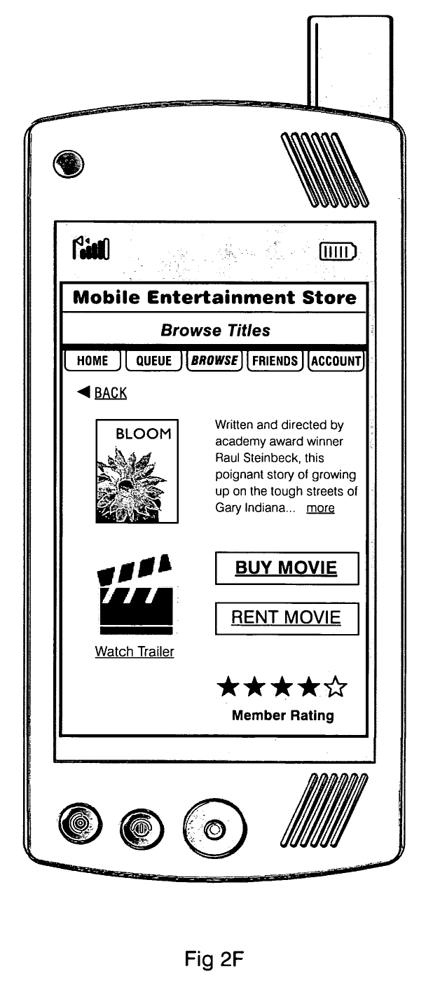

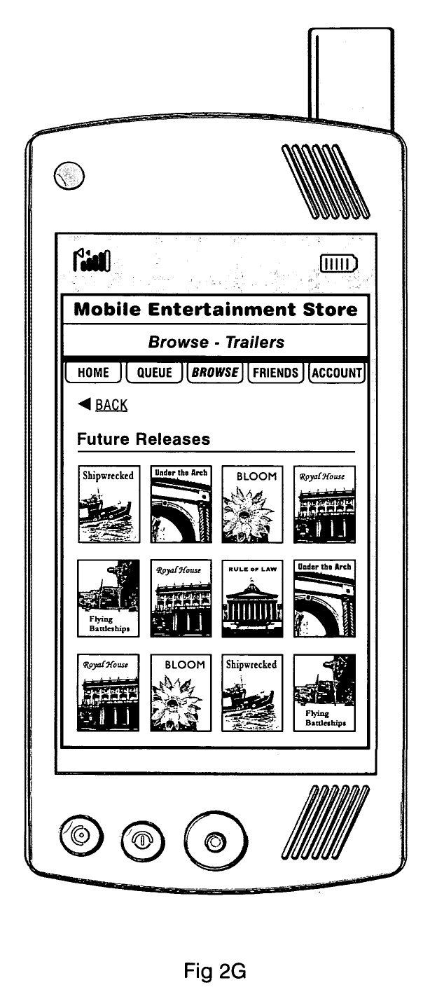

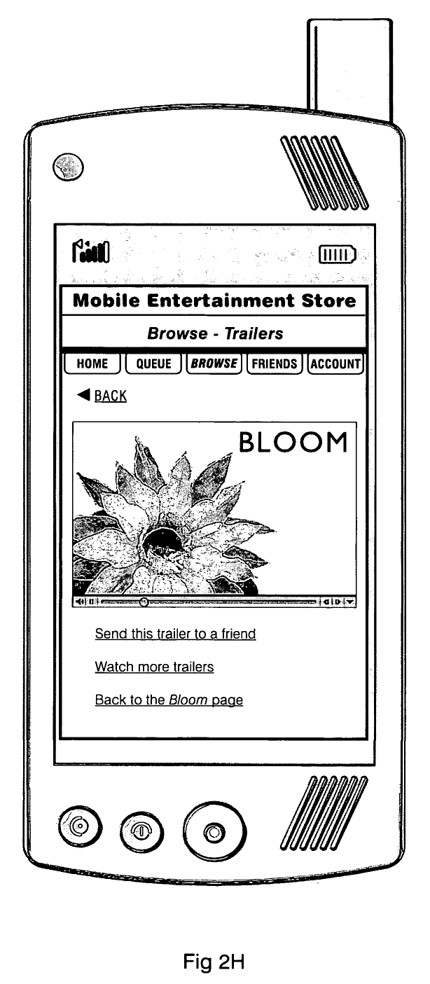

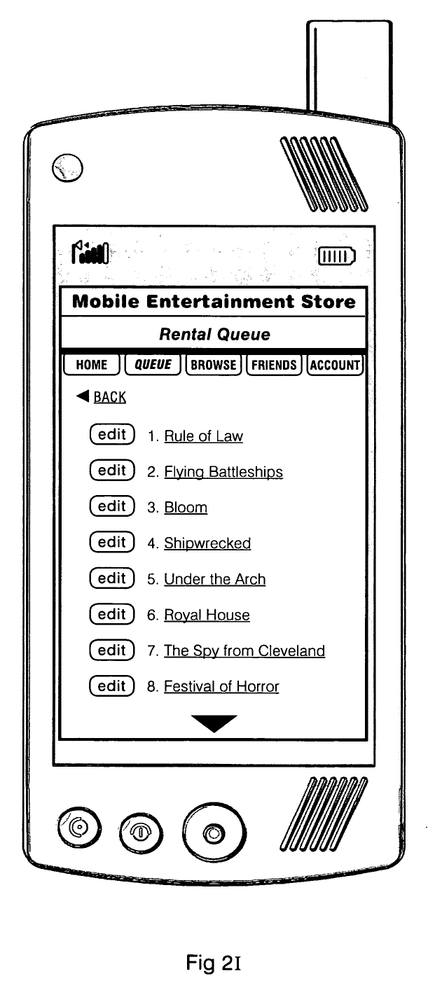

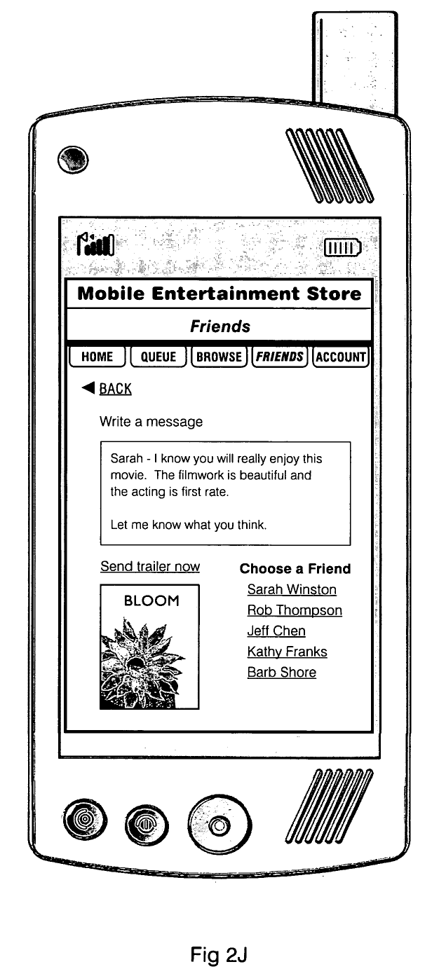

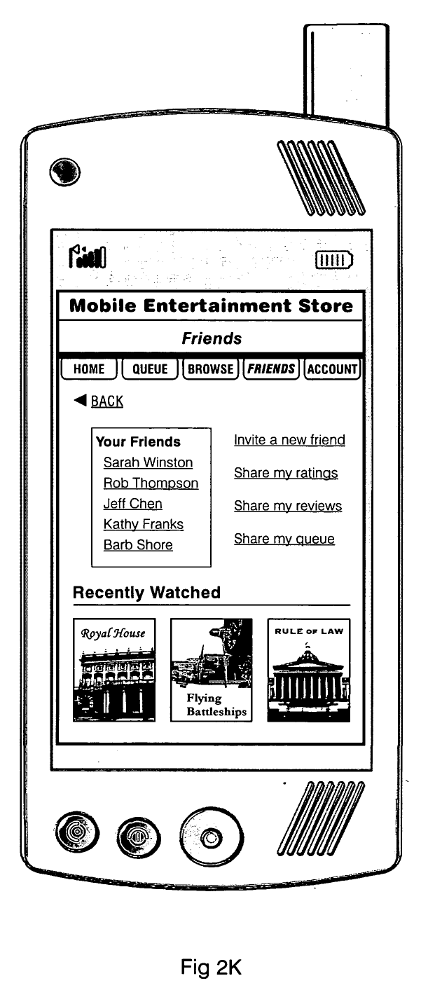

At the outset, the mobile carrier may invite its customers (users) to join a mobile store, in this example a movie store. A screen showing such an invitation on the handset (e.g., mobile phone is illustrated in FIG. 2A. If the user elects to join (become a member of) the mobile store, she may receive a message such as the one illustrated in FIG. 2B. Note that the offer may include a free trial period. The user may be informed that if she decides to continue with the plan after the trial period, the charges for purchases, rentals and/or subscription services will be billed to her monthly bill from the carrier.

If the user accepts the invitation, the mobile carrier transmits data that contains a list of available movie titles (step 102). This can be done periodically (e.g., weekly) with new titles being continually added to the list from which the store member may select.

The home page of the mobile store may look like the screen pictured in FIG. 2C. Options similar to those normally provided on website stores are included. For example, in this embodiment the home page includes tabs labeled “Home,” “Queue,” “Browse,” “Friends,” and “Account.”

There are a variety of ways in which the store member may view the list of available titles (step 104). For example, selecting the “Browse” tab may bring up a screen such as the one shown in FIG. 2D, which contains a catalogue of available movie titles. In this example, the store member has the option of reviewing “New Releases” or a list of titles “Recommended For You” that is based on the member's previous selections. An addition, a screen like the one shown in FIG. 2E may inform the store member of new trailers that have recently become available for viewing.

Selecting a title from the lists shown in FIGS. 2D or 2E may generate a screen such as the one shown in FIG. 2F. This screen provides a short synopsis of the selected title as well as a button that activates the trailer for the title. The average rating of other members of the mobile store as well as a button that will display reviews by other members may also be included in this screen. The store member may also choose to see trailers of titles that are to be released in the future, as shown in FIG. 2G.

If the store member decides to view the trailer, the carrier transmits the trailer to the store member's mobile phone (step 108), for viewing in real time. The trailer may be streamed across the network. When viewing the trailer, the store member may see a screen such as the one shown in FIG. 2H. The screen contains a window in which the trailer (typically 2 to 3 minutes long) is displayed.

If the store member decides to purchase or rent the title (step 110), she clicks an appropriate button on the screen shown in FIG. 2F, which transmits the selection to the mobile carrier (step 112).

In response to this instruction the mobile carrier arranges for the shipment of an optical recording disc containing the selected title to the store member (step 114). Preferably, this is done using a delivery service such as First Class Mail or a shipping service that assures delivery to the store member within 1-2 days. The optical disc is preferably a miniature optical disc within a cartridge of the kind described in U.S. Pat. No. 7,013,476, issued Mar. 14, 2006, or U.S. Patent Application No. 2006/0048167A1, published Mar. 2, 2006, each of which is incorporated herein by reference in its entirety. The advantage of providing a miniature optical disc of the kind described in U.S. Pat. No. 7,013,476 or U.S. Patent Application No. 2006/0048167A1 is that it may be playable in the member's mobile phone. Alternatively, the disc may be in another format such as DVD.

The carrier also records the charge for the purchase or rental of the disc in the member's account so that it can be included in the next periodic bill sent to the member (step 116).

As indicated above, there are numerous variations of the method according this invention. In one variation, the store member sets up a “rental queue” by selecting the “Queue” tab. This brings up a screen such as the one shown in FIG. 21. The store member has previously indicated how many titles she wishes to have at any one time. Initially, the requested number of titles from the top of the “rental queue” are shipped to the store member. Thereafter, the title that is at the top of the list is automatically shipped to the store member whenever she returns a title to the supplier.

In another variation, the store member may setup a “wish list” of titles she would like to purchase. She may conveniently purchase that disc whenever she is ready to have the cost added to her monthly bill.

Another optional feature allows the store member to share information about the movies that she has seen with friends who are also members. For example, by pressing the “Friends” tab, a screen such as that shown in FIG. 2J appears, allowing the member to transmit a trailer to a friend along with a message about the movie. Using a screen like the one in FIG. 2K allows the member to share, for example, her ratings, reviews, and rental queue with friends.

The manner of implementing the method of this invention will be evident to those of skill in the art. Mobile phones and other wireless handsets are commonly used to transmit data to and receive data from a mobile carrier. The handset may have a touch screen that allows the member to control the handset with a stylus or the handset may be controlled by means of an on-screen cursor that moves in response to the member's manipulation of a navigational pad or joystick and a track wheel, for example.

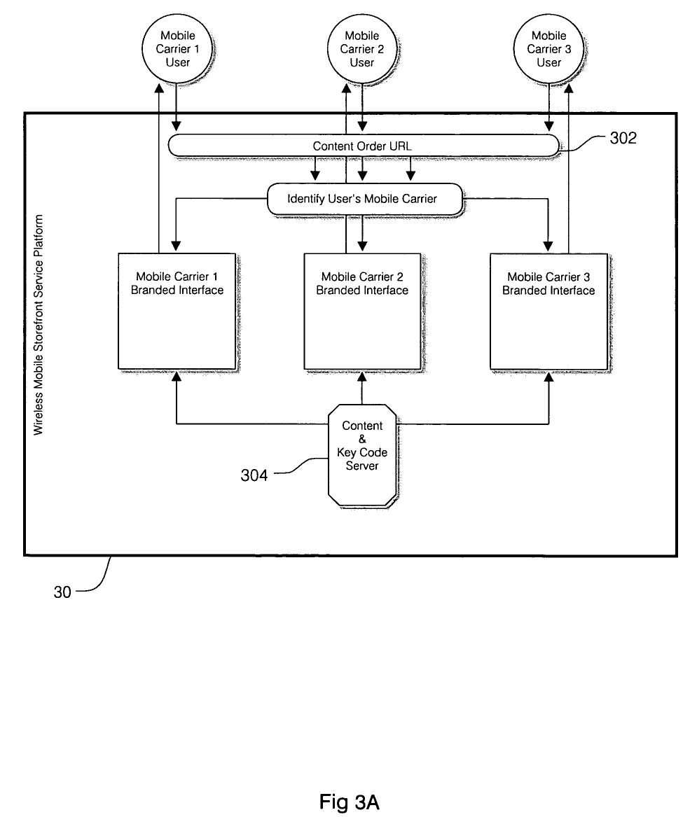

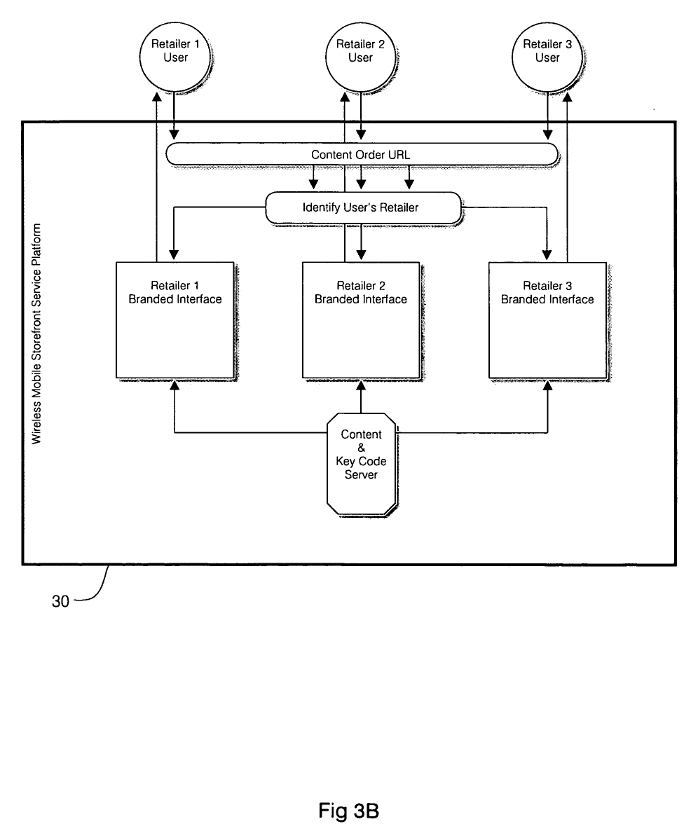

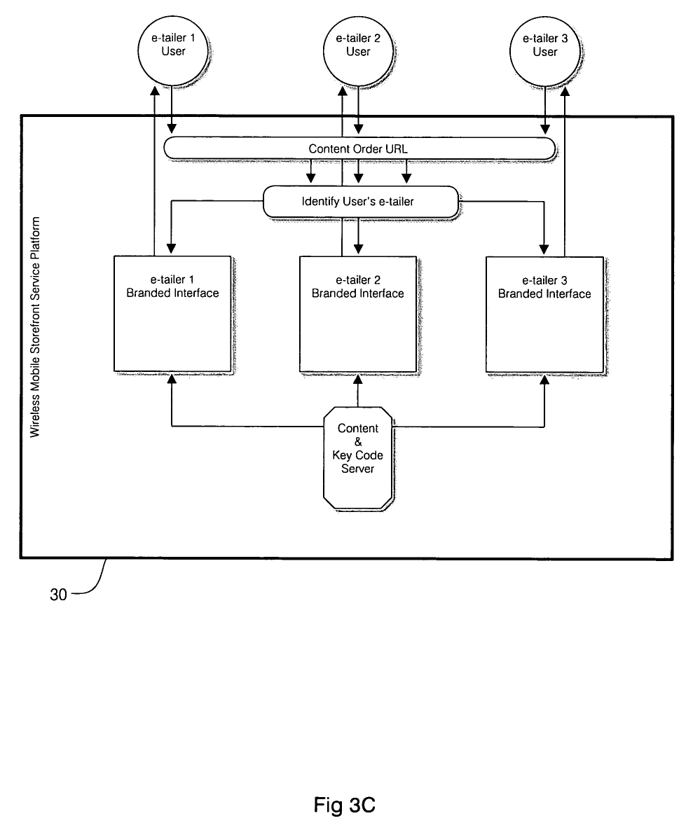

FIG. 3A illustrates a system architecture for a mobile storefront in accordance with the invention. In this embodiment, it is assumed that three mobile carriers, designated Mobile Carrier 1, Mobile Carrier 2 and Mobile Carrier 3, have teamed with a content aggregator to supply entertainment or educational content to their customers. The content aggregator operates a wireless mobile storefront service platform 30. Storefront service platform 30 has a content order Universal Resource Locator (URL) 302 which customers of Mobile Carrier 1, Mobile Carrier 2 and Mobile Carrier 3 access in order to preview and order the entertainment or educational content. When a customer accesses URL 302, mobile storefront service platform 30 identifies the particular mobile carrier of which she is a customer and displays the appropriate branded interface. Typically storefront service platform 30 and its operator are invisible to the customer. To the customer, the communication is with the mobile carrier.

Server 304 responds to requests and instructions from the customer and provides all of the graphical and other data that are required to process the communication with the customer (including, for example, the graphical data illustrated in FIGS. 2A-2K). Mobile carriers 1, 2 and 3 may choose to have their systems operate differently, in which case server 304 is programmed to function differently for the customers of each of the carriers. In particular, trailers for various forms of entertainment or educational content are stored on server 304, and upon request from the customer, the trailer is streamed to the customer's mobile phone or other portable wireless handset.

It will be evident to those of skill in the art that storefront service platform 30 may in reality be a server connected to the internet which is programmed to carry out the functions described above. The methods of programming storefront service platform 30 to carry out those functions are well known to those skilled in the art. Servers, such as the mobile storefront service platform 30, receive requests for data from client devices, such as a mobile phone. These requests are processed by the server, which potentially accesses additional servers (e.g., the mobile carrier's billing server) to obtain relevant data and subsequently responds to the client device (mobile phone).

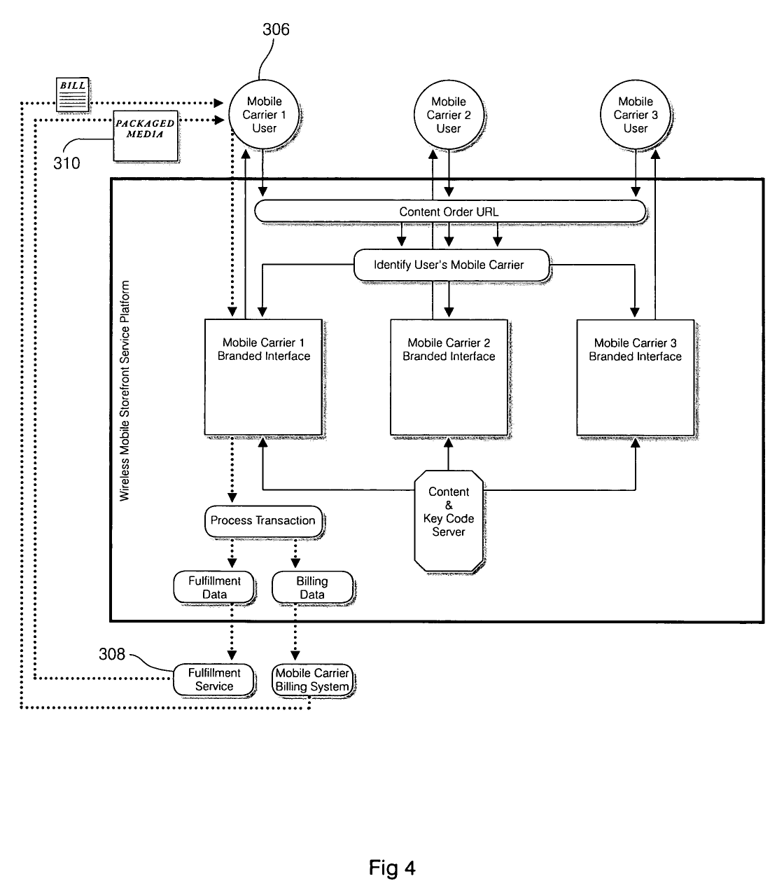

FIG. 4 illustrates how a typical purchase or rental transaction might be handled. It is assumed that a user 306 of Mobile Carrier 1 wishes to order an optical disc containing a movie or other content which she has previewed. The processing of the transaction takes essentially two parallel routes. Storefront service platform 30 notifies a fulfillment service 308 with which the operator of storefront service platform 30 has contracted, and fulfillment service 308 ships an optical disc 310 to user 306, preferably via an expedited delivery service provided by the U.S. Postal Service or a private firm. Contemporaneously, the billing data relating to the transaction—principally the item ordered, the price and the identity of user 306—are transmitted to Mobile Carrier 1, where this information is recorded for inclusion in the next periodic bill to be sent to user 306.

Where the user has established a rental queue as shown in FIG. 2I, the transaction may be handled somewhat differently. The fulfillment service 308 or another party who receives the returned disc notifies storefront service platform 30 that a disc has been returned. The user's rental queue is stored on storefront service platform 30, and storefront service platform 30 informs fulfillment service 308 which title is at the top of the user's rental queue. Fulfillment service 308 ships the appropriate disc to user 306. Storefront service platform 30 sends the applicable billing information to Mobile Carrier 1 for inclusion in the next bill to be sent to user 306.

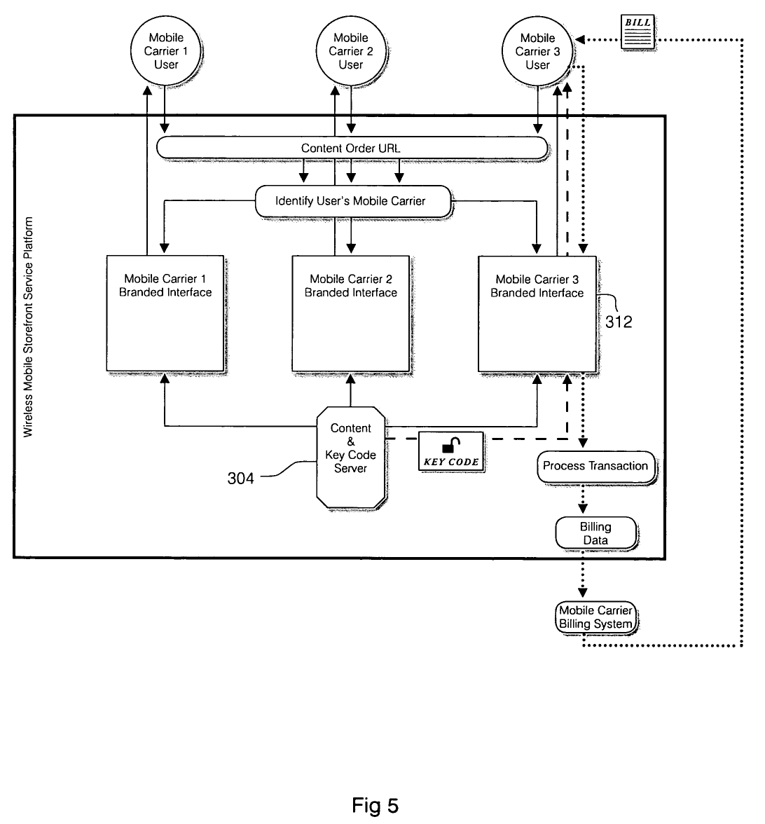

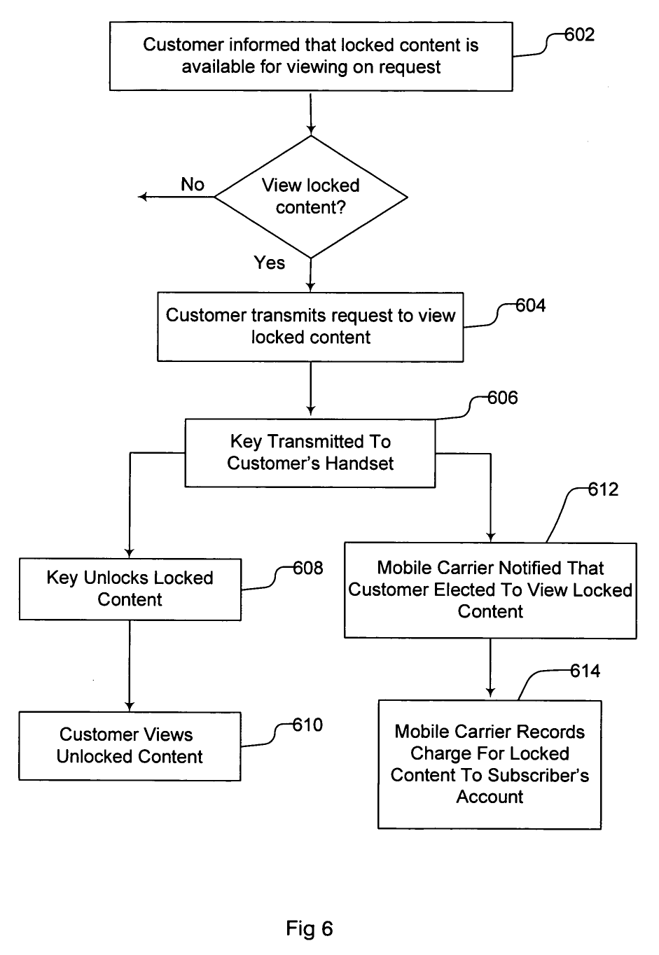

A variation of the method is illustrated in FIG. 5. A flow chart illustrating this variation is shown in FIG. 6. In this embodiment, the optical disc that is shipped to the user contains “locked” content that may be purchased for an additional charge. The user may be informed that she can view the locked content when she views the content which she previously ordered (step 602). She may be further informed that she may view the locked content by transmitting a request to the mobile carrier. In FIG. 5, a user 312 of Mobile Carrier 3 has ordered the locked content on a disc that she has received (step 604). In response to this order, content and key code server 304 transmits a code to user 312's mobile wireless handset (step 606). The code unlocks the content (step 608) and allows user 312 to view it (step 610). At the same time, content and key code server 304 transmits the relevant billing data of Mobile Carrier 3 (step 612), which records the data (step 614) so that it may be included in the next bill to user 312.

The original content on the disc may be viewed on any device with a compatible optical disc drive. The key codes for unlocked content may be stored on content and key code server 304. The key codes may be associated with the user's account number. Any mobile device associated with the user's account number (e.g., a new handset) will be able to play the unlocked content. Furthermore, some types of unlocked content may be “installed” on the mobile device (e.g., a ringtone or wallpaper image).

In alternative embodiments, the method of this invention does not involve a mobile carrier. For example, as shown in FIGS. 3B and 3C, a retailer or an “e-tailer” may invite its customers to join an mobile store which is accessed using the customer's mobile phone or other mobile wireless handset. Customers who join the mobile store are able to select and preview entertainment or educational content by accessing a content and key code server in a manner similar to that described above in connection with FIG. 3A. The content and key code server may communicate with the retailer's or e-tailer's server to provide the fulfillment and billing functions or the retailer or e-tailer may arrange with third parties to provide either or both of these services.

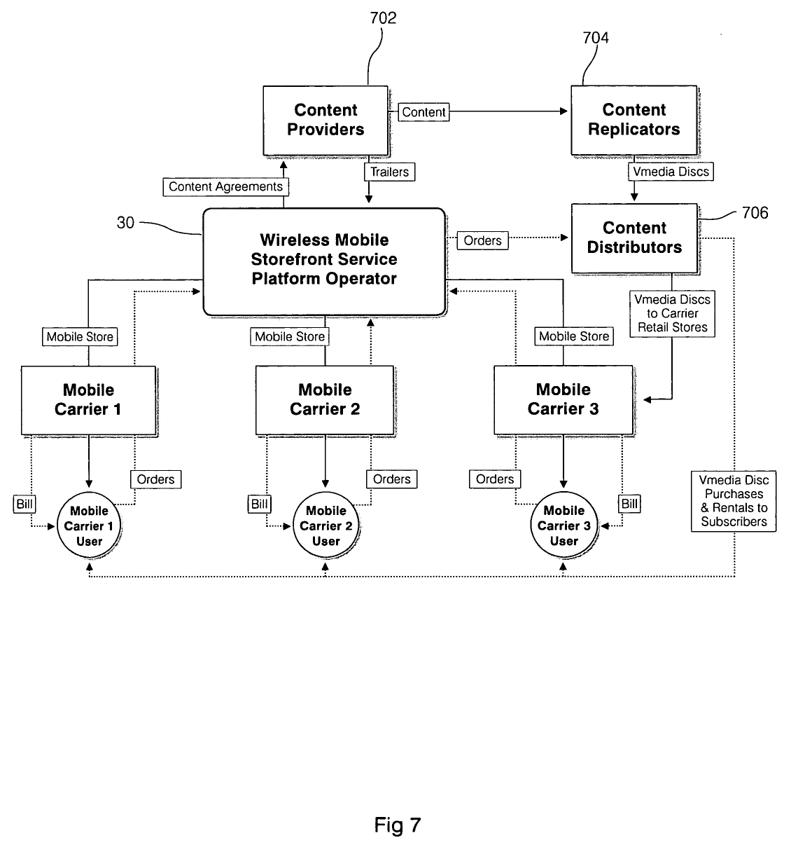

It will be evident from the above discussion that in the architecture shown in FIGS. 3A-3C the operator of the wireless mobile storefront service platform 30 must make arrangements to provide both the trailers and the optical discs to the user. A possible structure for this arrangement is shown in FIG. 7. In this structure the operator of the wireless mobile storefront service platform 30 contracts with a provider 702 of the content (e.g., a movie distributor) for trailers that are to be stored on the wireless mobile storefront service platform 30. The content provider 702 supplies the content to a disc replicator 704, which manufactures the discs that are to be delivered to customers. In turn, the disc replicator supplies the discs to a disc distributor 706, which ships the discs to customers. Note that the disc replicator and disc distributor may be the same firm. Alternatively, the fulfillment function may be performed by the mobile carrier, in which case the disc distributor may ship the discs to the mobile carrier.

While specific embodiments of this invention have been described above, it will be apparent to those of skill in the art that many additional and alternative embodiments are within the broad scope of this invention.

We claim:

1. A method of marketing content stored on an optical data storage disc using a portable wireless handset, the method comprising:
displaying a list of available titles on a customer's portable wireless handset;
using the handset to select one of the titles displayed on the handset;
ordering an excerpt of the selected title;
displaying the excerpt of the selected title on the portable wireless handset;
using the handset to order an optical data storage disc containing the selected title; and
shipping the optical data storage disc containing the selected title to the customer.

2. The method of claim 1 wherein the list of titles is a list of movies.

3. The method of claim 1 wherein the wireless handset is a mobile phone.

4. The method of claim 1 wherein using the handset to order an optical data storage disc containing the selected title comprising ordering the optical data storage disc from a mobile carrier.

5. The method of claim 4 wherein the method further includes billing the customer for the optical data storage disc.

6. The method of claim 5 wherein billing the customer for the optical data storage disc is performed by the mobile carrier.

7. The method of claim 6 wherein billing the customer for the optical data storage disc is performed on a bill which includes charges for telephone or wireless data services.

8. The method of claim 1 wherein ordering an excerpt of the selected title comprises transmitting a message for the portable wireless handset to a wireless mobile storefront service platform.

9. The method of claim 8 wherein the portable wireless handset comprises a miniature optical data storage disc.

10. The method of claim 9 further comprising transmitting or streaming the excerpt from the wireless mobile storefront service platform to the miniature optical data storage disc.

11. The method of claim 9 wherein the optical data storage disc comprises a second miniature optical data storage disc, the handset being capable of reading data stored on the second miniature optical data storage disc.

12. The method of claim 11 wherein the optical data storage disc includes locked content.

13. The method of claim 12 comprising ordering the locked content.

14. The method of claim 13 comprising transmitting a key to the portable wireless handset to enable the customer to unlock the locked content.

15. A data processing system programmed to perform the following method:
store a list of entertainment and/or educational titles;
transmit the list of entertainment and/or educational titles to a portable wireless handset;
store an excerpt from each of the entertainment and/or educational titles;
receive a request from the portable wireless handset for one of the excerpts; and
transmit or stream the excerpt to the portable wireless handset.

16. The data processing system of claim 15 programmed further to receive an order for one of the entertainment and/or educational titles.

17. The data processing system of claim 16 programmed further to transmit the order to a fulfillment service.

18. The data processing system of claim 17 programmed further to transmit information relating to the order to a billing service.

19. The data processing system of claim 15 wherein a URL is associated with the data processing system.

20. The data processing system of claim 19 further programmed to display a branded interface on the portable wireless handset when the portable wireless handset accesses the URL.
